(19) United States
(12) Patent Application Publication
(10) Pub. No.: US 2019/0313673 A1
(43) Pub. Date: Oct. 17, 2019

(54) PROCEDURE FOR FOOD STRUCTURE IMPROVEMENT PRIOR TO COOKING AND RELATED EQUIPMENT

(71) Applicant: NEXT COOKING GENERATION SRL, Alba Adriatica (TE) (IT)

(72) Inventor: Daniele DI CLERICO, Alba Adriatica (TE) (IT)

(21) Appl. No.: 16/309,605

(22) PCT Filed: Jun. 12, 2017
(86) PCT No.: PCT/IB17/53465

§ 371 Date: Dec. 13, 2018

(30) Foreign Application Priority Data
Jun. 16, 2016 (IT) 102016000062085

(51) Int. Cl. A23L 5/30; A22C 9/00; A23B 4/015; A23B 4/26; A23L 5/10; A23L 3/30; A23L 13/70

(52) U.S. Cl. CPC A23L 5/32; A22C 9/00; A23B 4/015; A23L 13/76; A23L 5/15; A23L 3/30; A23B 4/26

(57) ABSTRACT

The method and device, according to theoretical and experimental guidelines and related equipment, substantially modify, regarding the prior art treatment of food, especially of animal origin, the maturation and cooking phases, thus integrating most of the benefits of both processes. The method and device improve the characteristics of chewability, digestibility, presence of nutrients and hydration of the food. Moreover, the method and device ensure the absence of toxic substances due to cooking processes and improves the contribution of food marination and aromatic substances.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The fields of application of the invention in question may be identified:

Research in food technologies.

Large and small restaurants and catering.

Large and small distribution of food.

This invention relates to a new type of the device and the process bound to it, for the pre-cooking process and subsequent cooking phase of all foods, particularly those of animal origin.

### 2. Description of Related Art Including Information Disclosed Under 37 CFR 1.97 and 37 CFR 1.98

The treatment of some types of food before cooking is of fundamental importance in order to give such food some essential characteristics for human consumption, not only as regards the nutritional aspect but also regarding the taste of food and the pleasure derived from it. In this regard, the parameters such as the ease of chewing and the homogeneity of the tissues of food are not negligible and may deeply affect the success of sales and the distribution of the product. Speaking of meat, for example, the current state of the art provides processing protocol for certain cuts of this food so that the structure may change and enhance the characteristics to the detriment of others. It should be noted that the omission of these processing protocols before cooking make this food unpalatable and almost impossible to eat. The most important procedure for purposes of this transformation is Ageing, where the muscle loses its rigidity due to enzymatic, chemical and physical transformations, being transformed into meat for human consumption. We may define this pre-cooking phase as meat maturation. Currently Ageing consists in storing the carcass of the animal, once it has been opened and cleaned, in a vertical position in an environment with controlled temperature and humidity. During Ageing different phenomena occur, which also affect the commercial factors: for example the lowering of the PH value (i.e. the degree of acidity) of the muscle and the relative loss of water from the tissue. This phenomenon changes the weight of the food and then the economic yield of the meat cut. The basic hardness of meat, i.e. its tenderness characteristic, is a parameter that depends also on the connective tissue present therein, as well as on the parameters of quantity and quality of the crosslinks. The traditional cooking phase, which is carried out at high temperature, modifies the tenderness parameters in a range that is more acceptable but by doing so it gives the food undesired characteristics. The most important are:
1. The high moisture loss both of proteins and carbohydrates. This situation often results in the kitchen use of sauces and substances to be added to the food in order to rehydrate it and render it soft.
2. The loss of nutrients.
3. An uninviting aspect.

Lastly, it should also be stressed that not all cuts of meat are equal and therefore the processes of Maturation and cooking are to depend on variables that are hardly controllable and may be assimilated to a single standard process for all types of meat. Regarding this heterogeneity of behaviour in many categories of food, a study has been launched on the foods in order to understand how to improve the state of the art of Maturation and cooking the meat to obtain from different types of animal muscle meat a product with a higher quality and palatability than that obtainable today with the prior art with a better yield regarding all respects (chewability, hydration of food, presence of most nutrients etc). This result, furthermore, has been seen to impact positively also on the economic yield from the sale of these foods. The study in question has led to the synthesis of a procedure and a device that is the object of the idea of the invention.

### BRIEF SUMMARY OF THE INVENTION

The process of the present invention, according to theoretical and experimental guidelines and related equipment, has allowed us to substantially modify regarding the prior art treatment of food, especially of animal origin, the maturation and cooking phases, thus integrating most of the benefits of both processes. This process obtained according to the idea of the invention improves the characteristics of chewability, digestibility, presence of nutrients and hydration of the food. Moreover, this invention ensures the absence of toxic substances due to cooking processes and improves the contribution of food marination and aromatic substances.

### BRIEF DESCRIPTION OF THE SEVERAL VIEWS OF THE DRAWINGS

The present invention will now be described by way of example only, and with reference to the accompanying drawings.

FIG. 1 is a schematic view of the method and device, according to embodiments of the present invention.

FIG. 2 is a schematic view of a container of the device of embodiments of the present invention.

FIG. 3 is a schematic view of a container with marinating liquid, according to embodiments of the present invention.

FIG. 4 is a schematic view of a container with marinating liquid, showing permeability to ultrasound waves, according to embodiments of the present invention.

FIG. 5 is a schematic view of the method and device, showing more than one container, according to embodiments of the present invention.

FIG. 6 is a schematic view of the method and device, showing a cooking procedure, according to embodiments of the present invention.

FIG. 7 is a schematic illustration of the method, according to embodiments of the present invention.

FIG. 8 is a schematic view of a convex metal lens, according to embodiments of the present invention.

FIG. 9 is a graph illustration of power over time in the method, according to embodiments of the present invention.

### DETAILED DESCRIPTION OF THE INVENTION

Procedure.

The invention consists in the definition of a procedure (which has been found) according to theoretical and experimental guidelines, which have allowed us to design and build a machine for the treatment of foods in the Maturation and cooking phases, thus integrating most of the benefits of both processes. With the example of meat, we have tried to understand how to obtain a method of Maturation that should intensify even more the characteristics of the food and make it reach a state of Maturation better than that of the prior art. We will call this new type of Maturation a “Boosted Maturation”. To obtain the Boosted Maturation we have resorted to a physical system to change the characteristics of the meat that characterise the final Hardness, i.e. the high presence in certain cuts of this food of the connective tissue discussed under paragraph “State of the Art”. Excluding a priori a procedure for adding external substances, we have chosen a mechanical modelling action on the tissue provided primarily by waves of kinetic energy transmitted by ultrasound transducers. Such devices may in fact emit sound waves at a high frequency (with different levels of intensity and frequency) that impact on the food tissue when it is immersed in a liquid, causing a great change in the basic Hardness of the food. This is possible because the ultrasound waves inside the liquid create the formation of small air bubbles, which, due to the effect of the inhomogeneity of the pressure in the liquid itself, implode and allow to release their kinetic energy on the fibres of the food. This procedure was developed with the following conditions:

1. The meat must be immersed in a liquid to be affected in an effective manner by the ultrasounds but enclosed inside a container to allow not to be contaminated by the treatment liquid; such container shall permit the addition of aromatic and/or marinating substances during maturation. In fact, it has been proved that during this phase, the marinade and the presence of aromatic substances is particularly enhanced with respect to the prior art. The container that hosts the food must therefore be impermeable to liquids but permeable to the ultrasound waves transmitted in the liquid, making an effective transduction of these waves therein. This parameter must be taken into consideration during the electric driving of transducers; during this sequence, in fact, one must consider the transfer function of the energy in the container. The presence of the container that is impermeable to liquids and permeable to the ultrasound waves with its physical-mechanical characteristics is therefore essential to obtain a Boosted Maturation with ultrasound that allows important physical/structural food modifications.

2. The temperature of the food during boosted maturation with ultrasound must be kept constant in order to have excellent effectiveness. To ensure this condition can occur, it is necessary that the temperature of water or liquid surrounding the container where the food is inserted be treated with the emission of ultrasound waves, both controlled and then kept at the right value also by means of a recirculation that allows homogeneity in the distribution of thermal energy.

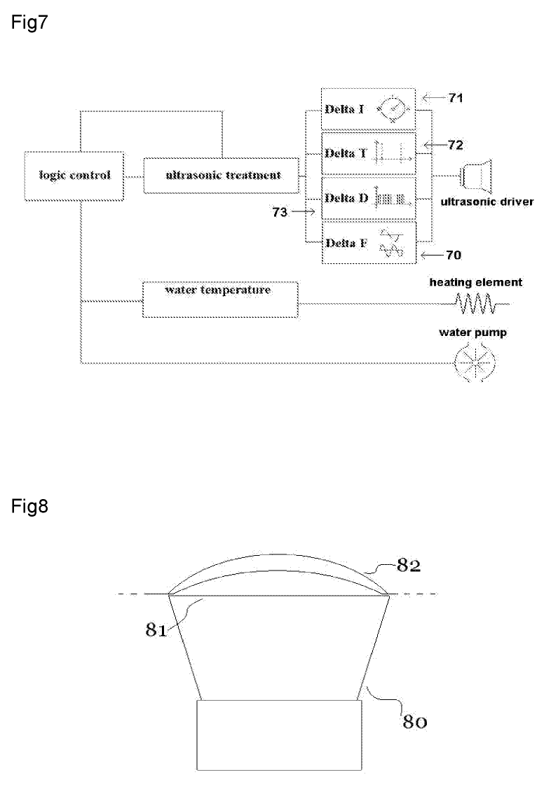

3. The modulation and the discretisation of the intensity of the ultrasound signal, the duration, range of frequencies and duty cycle are determined according to a function that is based on the idea of the invention. For every type of food subjected to the process of ultrasound Boosted Maturation there is a range of frequencies (DeltaF) [FIG. 7 (70)] a range of Power (DeltaI) [FIG. 7 (71) a range of duration (DeltaT) [FIG. 7 (72)] and a range of cycle of emission of the ultrasound in the unit of time, i.e. the Duty Cycle (DeltaD) [FIG. 7 (73) such as to stabilise the temperature of the liquid that immerses the food in a predetermined range, avoiding its uncontrolled increase due to the effect of ultrasound. This controlled temperature value allows to avoid the cooking of food during the maturation phase. To obtain this requirement, according to the idea of the invention, we carry out an analysis of the energy levels of the harmonics constituting the driving signal of the ultrasound. By associating a correct power value to the harmonics, it is possible to control the amount of energy and then check the variation of the temperature to which the liquid is subjected, by distributing different levels of this energy in the frequency spectrum of the driving signal of the ultrasound transducers.

4. The necessary temperature stabilisation is to be further controlled according to the idea of the invention through a decrease of the gas dissolved in the liquid contained in the tank. This is possible because the maturation process is started in the tank under vacuum, i.e. a physical state that allows the stabilisation of the gaseous exchange between the liquid and the air contained in the tank itself. The physical status of the vacuum decreases the effect of refraction of ultrasound waves during scattering in the liquid as the lesser presence of gas increases the ease of wave propagation and subsequently limits the increase in temperature of the liquid.

5. The physical status of the vacuum also allows to make constant the value of the acoustic impedance of the liquid, which then becomes a constant and not a variable. This factor is related to the amount of gas dissolved in the liquid. Making the value of the impedance of the liquid constant, this renders predictable the amount of power of the ultrasound wave in the impermeable containers that contain the product to be matured. This condition allows a controlled and stable scattering during time and for the energy transduced inside the container, allowing for control and a forecast of the result of the maturation induced by the ultrasound system.

Device.

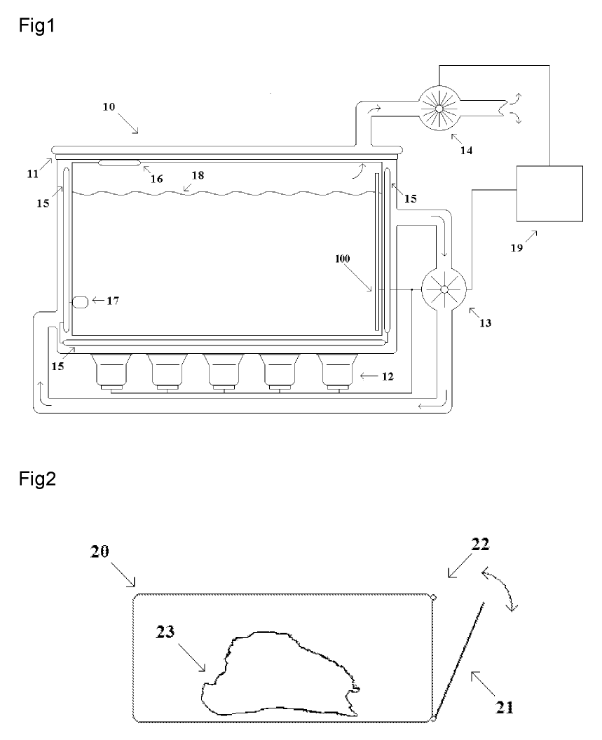

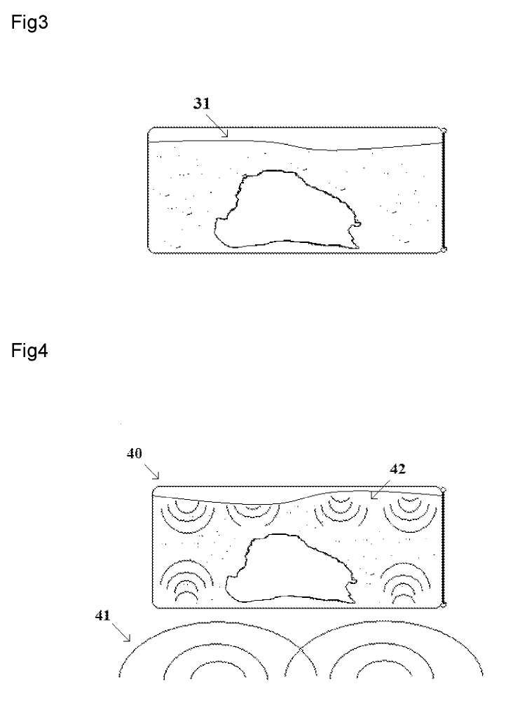

The device created on the basis of the idea of the invention consists in its main parts in a tank made of stainless steel or other material [FIG. 1) (10) fitted with watertight cover [FIG. 1) (11) and equipped with one or more arrays of transducers for ultrasound waves [FIG. 1) (12) that may be transmitted in its cavity. The ultrasound transducers are coupled to a diverging convex metal lens with the appropriate size, positioned in the area of emission of the transducer. This lens allows to focus the energy of the ultrasound wave and is suitably designed according to the limits of the physical law of Snell-Descartes on Refraction, in order to minimise the generation of standing waves. The liquid inside the tank [FIG. 1 (18)] is circulated by a pump [FIG. 1 (13) while a second air intake pump [FIG. 1) (14) allows you to create a state of vacuum when necessary, between the liquid contained in the tank [FIG. 1 (18)] and the watertight cover [FIG. 1) (11). There are heating elements [FIG. 1 (15)], pressure [FIG. 1 (16)] temperature [FIG. 1 (17)] and liquid level sensors [FIG. 1 (100)]. All devices listed inserted in the tank, i.e. those that generate ultrasound waves [FIG. 1 (12)], that measure pressure [FIG. 1 (16)], temperature [FIG. 1 (17)], liquid level [FIG. 1 (100)], which produce heating [FIG. 1) (15), which generate a vacuum [FIG. 1) (14) and which move the liquid inside the tank [FIG. 1 (13)] are controlled by an external PLC [FIG. 1 (19) equipped with the appropriate drivers and with a user interface that allows the operator to display a monitor of the states and/or programs and/or edit the desired functions. In particular the liquid level sensor [FIG. 1 (100)] allows you to automatically turn off the device that is the object of the idea of the invention, in order to avoid that the action of the ultrasound waves without the liquid contained in the tank (or with too low a level) is able to destroy the same equipment and/or make it dangerous for the user. The device made according to the idea of the invention of FIG. 1 capable of performing the treatment according to the idea of the invention is described in the chapter “Description of the invention: Procedure”, and it is designed to accommodate the container inside [FIG. 2 (20)). Such container is equipped with an openable side [FIG. 2 (21)] with hermetic closure [FIG. 2 (22) made of a material that is permeable to both a temperature conditioning supplied from the outside and the ultrasound waves generated outside it. There is food to be treated inside the container of FIG. 2 [FIG. 2 (23)). In addition to food, it is possible to insert in this container also a marinating liquid [FIG. 3 (31)] and/or contour substances that may improve the olfactory and/or taste and/or nutritional characteristics of the food. The structure of the food container [FIG. 4 (40)] is designed with a material such as to confer a strong permeability to ultrasound waves [FIG. 4 (41) coming from the outside from the ultrasound transducers [FIG. 1 (12)). These waves scatter inside [FIG. 4 (42)] thanks to the physical properties of the structural material with which the container is built according to the idea of the invention where the density of the material constituting the container is selected to assume a value of acoustic impedance entirely similar to that of the liquid in which the tank is immersed in. This physical characteristic, permitted for example by the modelling of plastic materials such as polypropylene and polyamide, allows the adaptation of acoustic impedance between the liquid and the container, allowing the maximum energy transfer of ultrasound waves in its interior. [FIG. 4 (40)).

Procedure of ultrasound boosted maturation by means of the device according to the idea of the invention.

The example show below reveal all the main phases of boosted maturation process, according to the idea of the invention

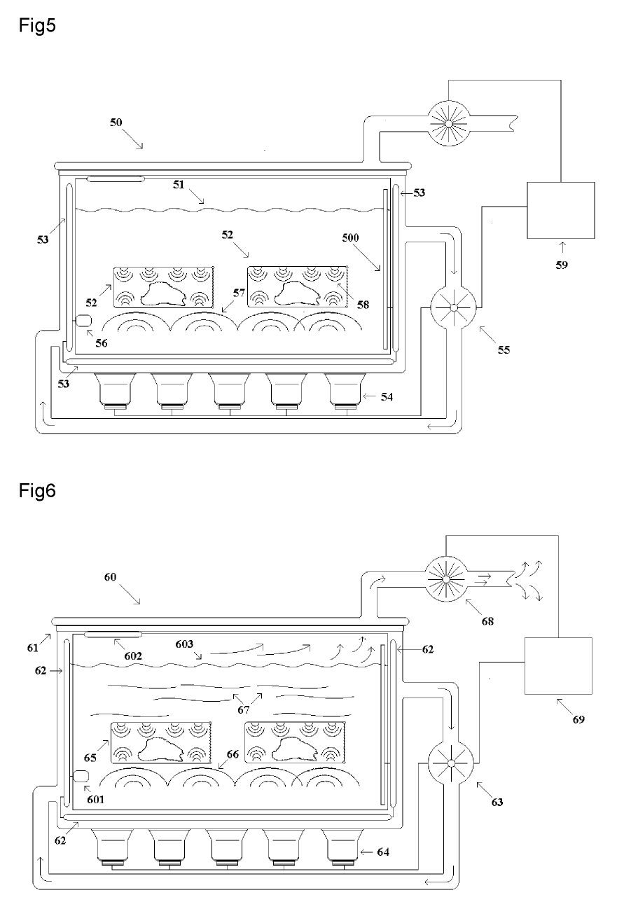

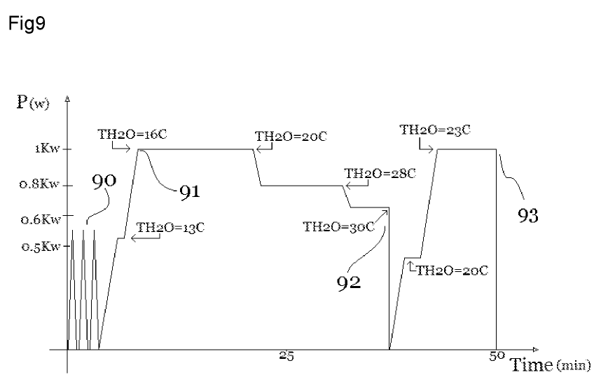

One or more containers of the food [FIG. 5 (52)] are placed inside the device for ultrasound boosted maturation, and more precisely inside the tank [FIG. 5 (50)] automatically filled with the liquid [FIG. 5 (51)] under the strict control of the level sensor [FIG. 5 (500)]. The device start the operation with a boot sequence that drive the ultrasound transducers with check signals. This sequence define the calibration level of power [FIG. 9 (90)]. Now the power is increased to the maximum value (from 1000 to 1200 Watt) [FIG. 9 (91)]. The liquid increase the temperature for the effect of ultrasound power, for example from 13 C.° to 16 C.°. The growing of the temperature start to decrease the natural oscillator frequency of the ultrasonic transducers also with the production of spurious harmonics. This effect decrease the efficiency of the power transfer to the food and the food maturation, because the optimum level of frequency is strictly focused around 40 KHz. For this reason, when the temperature rise the range of 18 C.° to 20 C.°, the power of ultrasound transducers is decreased, also using a non-continuous mode by modulation of DutyCycle, between 15% to 25% of the maximum value. When the temperature of the liquid is between 25° C. to 28 C.° the power to the ultrasonic transducers is decrease between 25% to 35% of the maximum value and when the temperature of the liquid is over 30 C.°, the device turn off the ultrasonic transducers [FIG. 9 (92)] and turn on the vacuum pump. The vacuum state take off the gas presence into the liquid. This operation allow a new stage of power feeding to the transducers with improved efficiency, that is with less growth of liquid temperature, because the gas dissolved in the liquid increase the power loss between ultrasonic transducers and food containers. During the process of vacuum, the circulation pump is put in on mode to decrease the liquid temperature. When the liquid is under 20 C.°, the power to the ultrasonic transducers rise to a range between 50% and 100% of the maximum value, depending of the maturation state of the food, until the process is completed [FIG. 9 (93)]. The stages of vacuum, circulation of the liquid and the power to the ultrasonic transducers may be repeat with a different pattern of this example, in relationship of type and quantity of food into the tank and the amount of maturation level programmed. Once the ultrasound Boosted Maturation has been carried out, the food inside of suitable containers [FIG. 2 (23)] has better physical/structural characteristics than a standard maturation process, i.e. that of the current State of the Art. The device made according to the idea of the invention at this point may optionally cook the food.

Cooking procedure by means of the device according to the idea of the invention.

Once the top cover [FIG. 6 (61)] of the tank [FIG. 6 (60)] has been sealed, the heating elements [FIG. 6 (62) will be activated to obtain an ideal liquid temperature [FIG. 6 (603)] and the speed of the pump is increased [FIG. 6 (63)] to create a greater and more sustained kinetic action given by the movement of the liquid [FIG. 6 (67)] in the food container [FIG. 6 (65). This action of the fluid, determined by the increased kinetic energy supplied by the pump [FIG. 6 (63)], is transmitted to the inside of the container [FIG. 6 (65)] thanks to the semi-rigid nature of the material of which it is composed. We then activate the ultrasound transducers [FIG. 6 (64)] using a different profile of energy emission with respect to that supplied during the ultrasound Boosted Maturation phase. At the same time we activate the pump [FIG. 6 (68) to suck the air contained inside the tank above the level of the water. The execution of the vacuum between the liquid [FIG. 6 (603)] and the top cover [FIG. 6 (61) allows to increase the effectiveness of the ultrasound stimulation to the container immersed, also amplified by the strong kinetic movement imparted to the water [FIG. 6 (67)] from the pump [FIG. 6 (63)]. All these features are enabled and adjusted by the PLC [FIG. 6 (69)] under strict control of the indications of the temperature[FIG. 6 (601)] and pressure [FIG. 6 (602)] sensor. Once we have completed the cooking procedure it is possible to extract the food from the tank [FIG. 6 (60)] and the related container [FIG. 6 (65).

### Advantages of the Invention

We describe below the advantages obtained by the processes of ultrasound Boosted Maturation according to the procedure and the device described according to the idea of the invention.

1. In ultrasound Boosted Maturation the food reaches a degree of homogeneity of the tissues greater than the state of the art of classical Maturation. This facilitates cooking, improves chewability and the nutritional quality of the treated food.

2. In ultrasound Boosted Maturation, we obtain a drastic reduction of the basic Hardness of the food if compared to the state of the art of classical Maturation.

3. In ultrasound Boosted Maturation, we carry out a transformation of the connective tissue of the food in its gelatinous form in a quantity greater than the state of the art of Ageing.

4. In ultrasound Boosted Maturation, we obtain a drastic reduction of the ageing time if compared to the state of the art.

5. In ultrasound Boosted Maturation, less water is lost from the tissues with respect to the state of the art of Ageing.

6. In ultrasound Boosted Maturation, it is possible to integrate in the food a marinade and/or aromatic substances with a higher efficiency with respect to the prior art in the treatment of foods.

7. Ultrasound Boosted Maturation takes place under strict control of the temperature on the food thanks to the method of parameterisation of the energy levels of the harmonics constituting the ultrasound wave.

8. Boosted maturation process of the invention is suitable also not only for animal fibres but also for vegetable fibres. Vegetable fibers under the boosted maturation process obtain a drastic reduction of the basic hardness and reaches a degree of homogeneity of the tissues. Boosted Maturation allow to obtain better performance during a subsequent cooking process and give the possibility in some vegetable to better remove peel or other no desirable part of the food.

We describe below the advantages obtained by the cooking methods according to the procedure and the device described according to the idea of the invention.

1. The food has the possibility to better stretch its fibres thanks to a distribution of heat without temperature gradients, resulting in a much more uniform method than traditional cooking. Cooking according to the idea of the invention is performed with the use of a quantity of energy lower than other food cooking methods (e.g., grid, oven etc.) and less time with respect to traditional cooking techniques. This provides a high energy yield of the cooking device according to the idea of the invention.

2. Cooking according to the idea of the invention increases the digestibility of food.

3. The low temperature does not allow the proteins to reach the isoelectric point and therefore this restricts the loss of water molecules.

4. The nutrients are preserved due to the effect of low temperature. Cooking according to the idea of the invention the food preserves more nutritional levels (e.g. proteins and enzymes) with respect to the various traditional cooking methods.

5. Cooking according to the idea of the invention the temperature values administered to food are lower than those of the various types of traditional cooking, always avoiding chemical-structural alterations that can lead to the formation of toxic substances.

6. Cooking according to the idea of the invention makes food more hydrated and more pleasant to mastication with respect to the various traditional cooking methods.

1) Procedure for the Maturation of food before cooking based on the controlled and parameterised administration of kinetic energy and thermal energy under vacuum of the cellular tissue forming the food by means of one or more transducers that emit ultrasound waves [FIG. 1 (12)] acting in a liquid [FIG. 1 (18) contained in a tank [FIG. 1) (10) placed in a vacuum state [FIG. 6 (68)], put in motion by a circulation pump [FIG. 1 (13) characterised by the following:
The liquid [FIG. 1 (18)] immerses the food to be treated [FIG. 2] (23), which is inserted into a suitable plastic container impermeable to liquid [FIG. 2 (22)] but permeable to ultrasound waves.
The ultrasound transducers [FIG. 8 (80)] are coupled to a convex lens [FIG. 8 (82) positioned in the area of emission of the ultrasound transducer [FIG. 8 (81).

2) Maturation procedure according to claim 1 in which the levels of Intensity, Modulation, range of Frequencies and the Duty Cycle of the energy supplied to the food through the ultrasounds are parameterised [FIG. 7] in order to keep constant the temperature of the liquid in the tank [FIG. 1 (10)] and stabilise the presence of gas dissolved in the liquid [FIG. 1 (18)].

3) Procedure for cooking food carried out by the administration of ultrasound [FIG. 6 (64)], a thermal method [FIG. 6 (62)] and the administration of kinetic energy to the food placed in the appropriate container [FIG. 6 (65) thanks to the forced circulation of liquid [FIG. 6 (63)(67)]. This cooking is performed under vacuum [FIG. 6 (68)] and at a controlled temperature to obtain a limited thermal shock on the food.

4) Equipment capable of applying the procedures of ultrasound Boosted Maturation and cooking of claims 1, 2 and 3, constituted by a tank [FIG. 1 (10)] that is sealed and openable [FIG. 1) (11), capable of generating the state of vacuum thanks to an air suction pump [FIG. 1 (114)], an array of ultrasound transducers integrated into the tank [FIG. 1 (12)], a recirculation system of a liquid contained therein [FIG. 1 (13)] with an automatic control of its level [FIG. 1 (100)], a heating system of all the walls of the tank by means of electrical resistance [FIG. 1) (15), a series of temperature [FIG. 1 (17)] and pressure sensors [FIG. 1 (16)] and one or more waterproof plastic containers [FIG. 5 (52).

5) Equipment of claim 4, wherein each electronic and electromechanical device related to it [FIG. 1 (12)(13)(14)(15)(16)(17)(100)] is controlled by a PLC [FIG. 1 (19)] with which the user may start, stop, edit and add one or more procedures for cooking and ultrasound Boosted Maturation.

6) Plastic material that is impermeable to liquids [FIG. 2 (20), insertable inside the tank of the equipment of claims 4 and 5, capable of being scattered inside an ultrasound wave [FIG. 4 (42)] when stimulated with an ultrasound transducer characterised by the density of the material of which it is composed, which confers an acoustic impedance equal to the value of the liquid in which it is immersed [FIG. 5 (52)] in the tank.

7) Plastic material container that is impermeable to the liquids of claim 6 [FIG. 4 (40), permeable to thermal conditioning induced from the outside.

8) Device according to claims 5 and 6, equipped with an improved energy efficiency compared to the state of the art thanks to the use of the ultrasound transducers [FIG. 6 (64)] and the state of vacuum [FIG. 6 (68)] that increases the efficiency of the scattering of the ultrasound waves in the liquid [FIG. 1 (18)].
